(19) United States
(12) Patent Application Publication
(10) Pub. No.: US 2004/0268399 A1
(43) Pub. Date: Dec. 30, 2004

(54) Network system, server, data recording and playing device, method for the same, and program

(75) Inventor: Yasuo Asakawa, Kawasaki-shi (JP)

Correspondence Address: IBM CORPORATION, IPLAW IQ0A/40-3, 1701 NORTH STREET, ENDICOTT, NY, 13760, US

(73) Assignee: INTERNATIONAL BUSINESS MACHINES CORPORATION, ARMONK, NY

(21) Appl. No.: 10/876,067

(22) Filed: Jun. 24, 2004

(30) Foreign Application Priority Data
Jun. 27, 2003 (JP) 2003-184789

(51) Int. Cl. H04N 7/173; H04N 5/91; H04N 5/445; H04N 7/00; H04N 7/16

(52) U.S. Cl. 725/89; 386/46; 725/58; 386/89; 725/134; 725/142; 725/88; 725/115

(57) ABSTRACT

A system for implementing a detailed and flexible searching function for programs to a data recording/playing device that records broadcast programs such as those delivered on TV. The system includes a search server 20 and a data recording/playing device 10 connected with each other over a network 30. The data recording/playing device 10 stores a data file of a given broadcast program and sends a search request specifying a program and a search condition to the search server 20. The search server 20 holds information on a given program, and at the same time, creates index information to be used for playing the program on the basis of information on the program, and sends the index information back to the data recording/playing device 10 in response to a search request from the data recording/playing device 10.

### FIELD OF THE INVENTION

The present invention relates to a data recording/playing device for recording motion picture programs and audio programs such as those delivered on television, and more particularly to a system and method for searching programs by their contents.

### BACKGROUND OF THE INVENTION

As the storage capacity of magnetic disks has increased, devices that use a magnetic disk as a recording medium are replacing VCRs (Video Cassette Recorder) as data recording and playing devices for recording and storing motion picture and audio programs (e.g.,Published Unexamined Patent Application No. 2003-108371). Data recording/playing devices of this type such as HDD recorders and home servers have a magnetic disk of a large capacity so that they can record and preserve a significant amount of (i.e., dozens of hours of) programs obtained from television broadcast and the like.

This type of data recording/playing device does not have a function for searching recorded programs or, if any, has only a simple search function for use in reproducing recorded programs. For example, some data recording/playing devices designed mainly for recording television broadcast provide preprogrammed recording functions using EPG (Electronic Program Guide) for digital broadcasting. Utilizing the EPG, one can search recorded data on a program-by-program basis.

Meanwhile, as networking environments including the Internet have become commonplace, sites (servers) that provide a variety of services over networks have been realized, distributing actual programs or allowing one to search for information about programs broadcast on television or on the radio using stations or dates and times of broadcast as keys (e.g., Published Unexamined Patent Application No. 2001-273305).

As mentioned above, data recording/playing devices for recording programs that are delivered on television and the like have no function for searching recorded programs or just have simple search functions. Thus, once an enormous amount of programs has been recorded for an extended period of time, it takes a good deal of time and effort for a user to find a program or a scene he/she wants to see.

Even when performing a search utilizing EPG, one can only specify a search target on a program-by-program basis and still have difficulty in finding a particular scene in a specific program. In addition, EPG does not provide a flexible search capability as desired by some users such as collecting particular scenes from multiple programs and reproducing them.

Where a program is obtained over a network, the creator of the program can add arbitrary index information to it for use in searching the program, however, this approach requires a lot of time to obtain data since the program itself needs to be downloaded along with its index information. Moreover, this is a service that provides index information together with programs kept by a server, thus is not designed to provide index information for programs obtained from a television broadcast and the like.

Also, a server that searches for information about programs broadcast on television and the like using stations and dates and times of broadcast as keys is not intended to provide information serving as an index when a program obtained by a data recording/playing device is replayed.

In view of these problems, an object of the invention is to implement a system that provides a detailed and flexible function for searching programs for a data recording/playing device that records programs such those delivered on television.

### SUMMARY OF THE INVENTION

The invention that attains the object is implemented as a network system having a configuration as follows. The system includes a data recording device for storing at least one program and a server for holding information on the at least one program stored in the data recording device and generating, in response to a request from the data recording device, a playlist to be used for playing all or part of the at least one program on the basis of the information on the at least one program to send the playlist to the data recording device.

More particularly, the server includes an annotation information storing unit for storing annotation information which contains information on at least one program delivered, an annotation information search unit for searching the annotation information matching the search condition and the at least one program specified in a search request received via a network, and a playlist generation unit for generating a playlist to be used for playing at least one program by using the search result to send the playlist to a requester of the search.

The server can further include a program receiving unit for receiving at least one broadcasted program and an annotation information generation unit for generating, by analyzing the at least one program received by the program receiving unit, annotation information to store the annotation information in the annotation information storing unit.

The annotation information further contains information on a broadcast station which broadcasts the at least one program, a date and time of broadcast, and the type of program. The playlist includes at least one play item which is used for identifying a portion of the at least one program by using the broadcast time of the at least one program.

Meanwhile, the data recording (and playing) device includes a program storing unit for storing at least one program as a data file, a search request unit for generating a search request which contains information about the at least one program and a search condition to send the search request to a server, and a program playing unit for playing all or part of the at least one program stored in the program storing unit on the basis of the response from the server to the search request.

The data recording/playing device may further include a program receiving unit for receiving a broadcast program to be stored in the program storing unit, means for obtaining information on a broadcast station which broadcast the at least one program and a broadcast time from conditions at reception of the at least one program, and means for passing the information and the time to the search request unit as identifying information of the at least one program.

In the data recording/playing device, the search request unit obtains the broadcast time of the at least one program requested by a search request as a response to the search request, and the program playing unit plays a portion corresponding to the broadcast time obtained as a response to the search request in the at least one program stored in the program storing unit.

The invention for attaining the object above is also implemented as a program playing method for playing at least one program stored on a storage medium. The program playing method includes the steps of generating a search request containing information on at least one program and a search condition to send the search request to a server; receiving information identifying a portion of the at least one program as a response to the search request, the portion matches the search condition; and playing the portion of the at least one program stored on the recording medium, the portion is identified by a response to the search request.

The invention is also implemented as a data processing method as follows. The data processing method includes the steps of generating, by analyzing at least one program broadcasted, annotation information on a broadcast station which broadcasts the at least one program, a date and time of broadcast, and the type of program; searching the annotation information for information matching a search condition and a program specified in the search request; and generating a playlist to be used for playing the program by using the search result to send a playlist to a requester of the search.

The invention can be also implemented as a program for controlling a computer to implement functions of the server and the data recording playing device mentioned above and a program for causing a computer to execute processes corresponding to the steps of the program playing method and the data processing method. The programs can be distributed stored on a magnetic disk, optical disk, semiconductor memory, or other type of recording media, or delivered over a network.

### BRIEF DESCRIPTION OF THE DRAWING

FIG. 1 is a block diagram showing an overall configuration of a system for implementing a search service in accordance with an embodiment of the invention.

FIG. 2 is a block diagram schematically showing an example of the hardware configuration of a computer for implementing a search server of the embodiment.

FIG. 3 is a functional block diagram of a data recording/playing device of the embodiment.

FIG. 4 is a functional block diagram of a search server of the embodiment.

FIG. 5 shows an example of annotation information generated for a given program, showing annotation information for the portions containing commercials in the embodiment.

FIG. 6 shows an example of annotation information generated for a given program, showing annotation information for the times when a goal was scored in a soccer match in the embodiment.

FIG. 7 shows an example of annotation information generated for a given program, showing the combination of the annotation information in FIGS. 5 and 6 in the embodiment.

FIG. 8 shows an exemplary program list used in the embodiment.

FIG. 9 shows an example of the design of an entry screen (search screen) for search conditions in the embodiment.

FIG. 10 is a flowchart illustrating the operation of a play list creating unit of the search server that has accepted a search request from a given data recording/playing device in the embodiment.

FIG. 11 is a flowchart illustrating the operation of the play list creating unit for detecting times in annotation information that match a search condition in the embodiment.

FIG. 12 shows an example of a screen showing a play list as a search result from the search server.

### DETAILED DESCRIPTION

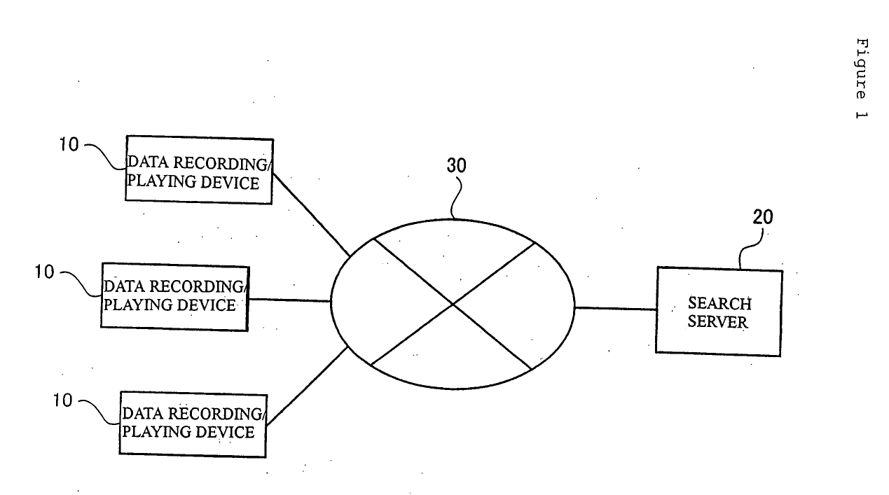

The invention will be described in detail based on its embodiments shown in the accompanying drawing. FIG. 1 shows an overall configuration of a system for implementing a search service according to an embodiment of the invention. As shown, the search service system of the embodiment includes data recording/playing devices 10 and a search server 20 that are connected with each other over a network 30 such as the Internet.

The data recording/playing device 10 records and preserves programs such as motion pictures and audio on a predetermined recording medium. While the embodiment will be described in the context of a HDD recorder that uses a magnetic disk as a recording medium to record programs delivered on television, the device may be a device that employs other recording media (such as DVD (Digital Versatile Disc)) and may record any programs that can be handled by the search server 20, not limited to programs delivered on television. As an example, even a video program that is created and distributed for particular users can be subjected to the search service of the embodiment as long as the search server 20 is permitted to handle the video program. The data recording/playing device 10 can also be implemented by a personal computer and other types of computers that have a storage device such as a magnetic disk and the like. The network function is required for accessing the search server 20 over the network 30.

The search server 20 can be implemented by a personal computer, workstation or other type of computer and provides a search service for programs stored by the data recording/playing devices 10.

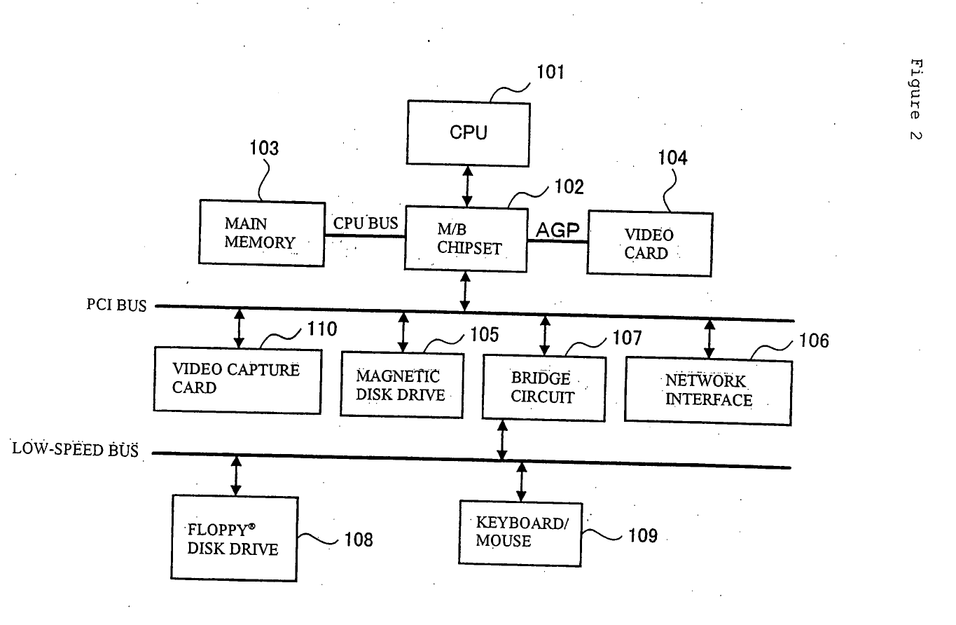

FIG. 2 shows a block diagram of an example of the hardware configuration of a computer for implementing the search server 20. The computer shown in FIG. 2 includes a CPU (Central Processing Unit) 101 as operation means, main memory 103 that is connected to the CPU 101 through a M/B (motherboard) chipset 102 and a CPU bus, a video card 104 that is also connected to the CPU 101 via the M/B chipset 102 and an AGP (Accelerated Graphics Port), magnetic disk drive (HDD) 105 that is connected to the M/B chipset 102 via a PCI (Peripheral Component Interconnect) bus, network interface 106, floppy disk drive 108 and keyboard/mouse 109 that are connected to the M/B chipset 102 through a bridge circuit 107 and a low-speed bus such as an ISA (Industry Standard Architecture) bus from the PCI bus. The computer also includes a video capture card 110 for organizing delivered motion picture programs into data files.

FIG. 2 only illustrates one example of a hardware configuration of the computer for implementing the embodiment, and various other configurations are possible. For example, instead of the video card 104, only video memory may be provided with the CPU 101 processing image data, or a CD-R (Compact Disc Recordable) drive or a DVD-RAM (Digital Versatile Disc Random Access Memory) drive may be provided via an interface such as ATA (AT Attachment) or SCSI (Small Computer System Interface) as an external storage device.

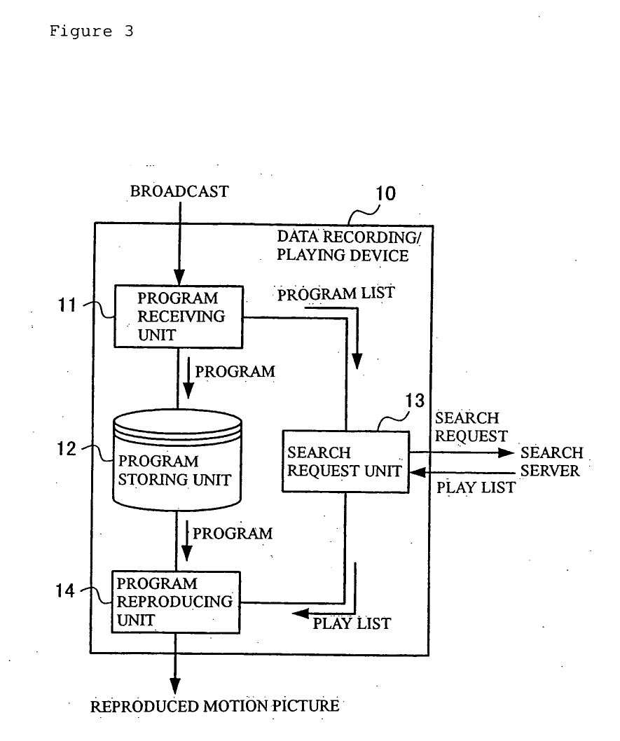

FIG. 3 is a functional block diagram of the data recording/playing device 10. With reference to the figure, the data recording/playing device 10 of the embodiment includes a program receiving unit 11 for receiving broadcast programs, program storing unit 12 for storing received programs, search requesting unit 13 for generating and sending search requests to the search server 20, and program reproducing unit 14 for reproducing programs stored in the program storing unit 12.

In the configuration, the program receiving unit 11 is implemented by a receiver similar to a receiver of a television receiving set and a CPU controlled by a program. It receives broadcast programs and sends them to the program storing unit 12, also obtains information for identifying the programs from conditions present during reception (such as information identifying a station (channel) and a broadcast time (start time and end time of a program)) and sends such information as a program list to the search request unit 13.

The program storing unit 12 is implemented by a magnetic disk drive (or the like), organizes programs received by the program receiving unit 11 into data files and stores them in a predetermined storage area of the magnetic disk that serves as a recording medium.

The search request unit 13 is implemented by a program-controlled CPU and caches the program list received from the program receiving unit 11. The search request unit 13 in accordance with a user's direction, generates a search request including the program list for a desired program, sends the search request to the search server 20 over the network 30, and receives a play list as a response. The play list received is sent to the program reproducing unit 14. As described later in more detail, a play list is a list of information that locates a desired scene in a program being searched, serving as index information to be used in reproducing the program. The list describes times at which the scene being searched was broadcast.

The program reproducing unit 14 is implemented by the program-controlled CPU, and reads a data file for a desired program from the program storing unit 12 according to the user's direction and obtains a play list for the program from the search request unit 13. The program reproducing unit 14 reproduces a scene specified by the play list. As mentioned above, when a play list locates a particular scene in a program with a time when the scene was broadcast, a portion corresponding to the time described in the play list will be reproduced.

The program reproducing unit 14 can also present the play list to the user and accept a direction to replay the program. Here, the user can specify a given portion for reproduction based on the play list and enter a direction to reproduce the scene. The program reproducing unit 14 then reproduces the scene specified by the user.

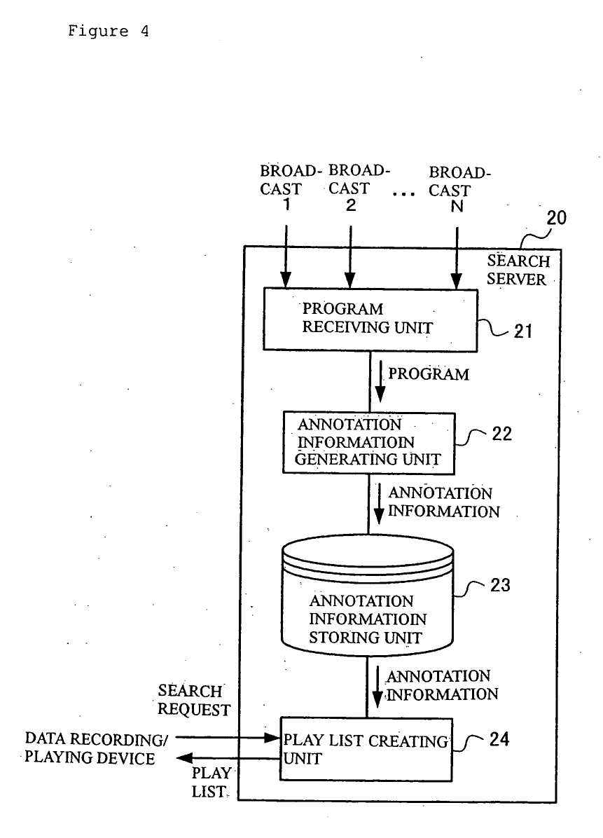

FIG. 4 is a functional block diagram of the search server 20. As shown, the search server 20 of the embodiment includes a program receiving unit 21 for receiving broadcast programs, annotation information generation unit 22 for generating annotation information for received programs, annotation information storing unit 23 for storing and maintaining generated annotation information, and a play list creation unit 24 for creating a play list of a given program on the basis of a search request sent by the data recording/playing device 10 and annotation information stored in the annotation information storing unit 23.

In the configuration, the program receiving unit 21 is implemented by a receiver similar to that of a television receiving set, for example, the video capture card 110 and the program-controlled CPU 101 shown in FIG. 2, and the program receiving unit 21 receives broadcast programs and sends them to the annotation information generation unit 22. Also, the program receiving unit 21 of the search server 20 can handle multiple broadcasts and receive programs delivered by those broadcasts simultaneously. In the example in FIG. 4, the program receiving unit 21 receives N broadcasts.

The annotation information generation unit 22 is implemented by the program-controlled CPU 101 in FIG. 2, for example, and analyzes programs passed from the program receiving unit 21 and generates annotation information to be used for searching the programs. As annotation information, arbitrary information can be set, including information for detecting commercials inserted at the time of broadcasting, for detecting characters displayed on a screen, for detecting portions where a player scores a point or a particular team attacks in a sports or game program such as soccer and baseball, for example. It is also possible to generate multiple pieces of annotation information for one program such as generating information on the times when a player scores and information on the times when a team attacks the opponent team for each team in a game program, for example. Annotation information may be generated with a manual operation by an operator of the search server 20 or automatically generated. As an example, functions of skipping commercials on the basis of distinction between stereo and monaural audio have been implemented for TV broadcast recording, which can be utilized to determine where commercials are inserted and generate annotation information accordingly.

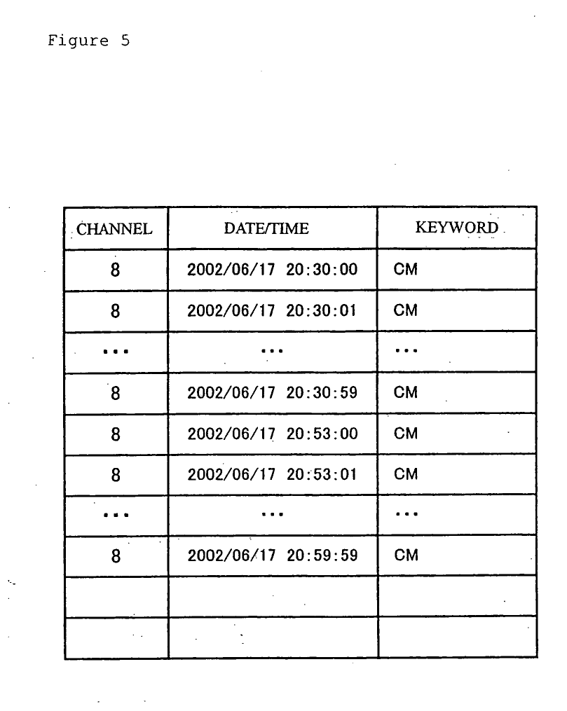

FIGS. 5 to 7 show examples of annotation information generated for a given program. Assume that this is a recording of a soccer match that was broadcast on Jun. 17, 2002 on Channel 8. The annotation information shown in FIG. 5 is for detecting where commercials are inserted in the program. With reference to the figure, a broadcast channel and dates and times of broadcast (in seconds) are provided for determining the arrangement of the program and commercials, as well as a keyword “CM” for identifying the type of recorded data. The annotation information shows that in this program commercials exist in portions broadcast between 20:30:00 and 20:30:59 and between 20:53:00 and 20:59:59.

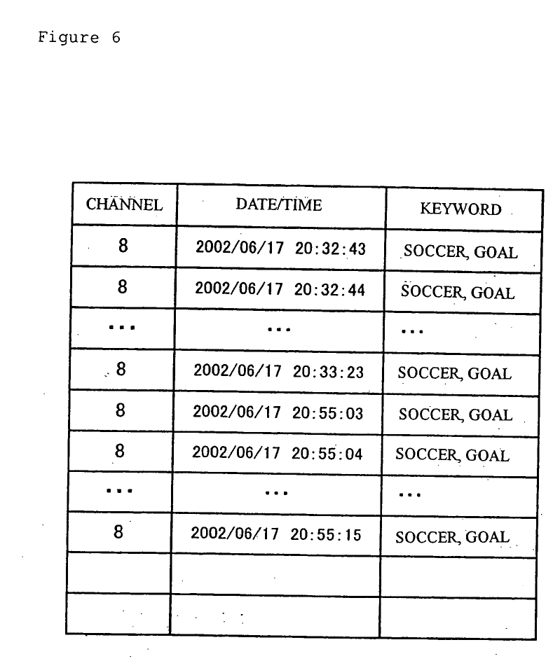

Likewise, the annotation information shown in FIG. 6 is for detecting the times when a goal is scored in the program. With reference to the figure, a broadcast channel and dates and times of broadcast as well as keywords “soccer, goal” are registered. This annotation information shows that a goal was scored between 20:55:03 and 20:55:15, however, the annotation information in FIG. 5 shows that a commercial was on the air during this time period. This means that an image of soccer goal scoring was used in the commercial.

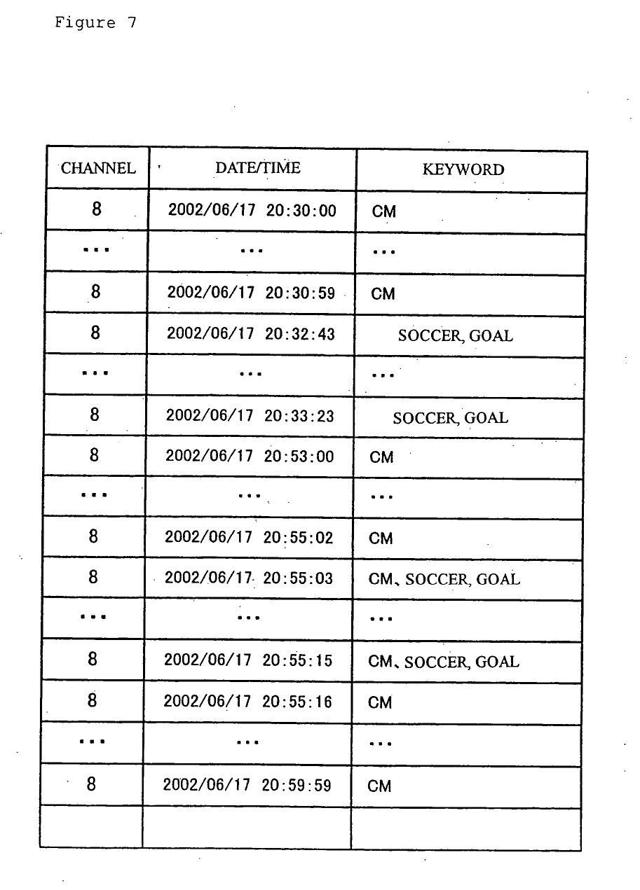

FIG. 7 is a combination of the pieces of annotation information of FIGS. 5 and 6. As shown, the information for detecting commercials in FIG. 5 and that for detecting the times when a goal was scored in FIG. 6 are arranged chronologically. For the portion between 20:55:03 and 20:55:15 mentioned above, keywords from the two pieces of annotation information are registered in combination as “CM, soccer, goal”. Annotation information thus generated is sent to and stored in the annotation information storing unit 23.

The annotation information storing unit 23 may be implemented by the magnetic disk 105 shown in FIG. 2, and stores and preserves annotation information generated by the annotation information generating unit 22. In this embodiment, the search server 20 has to maintain only annotation information, and programs themselves need not to be preserved at the search server 20.

The play list creating unit 24 is implemented by the program-controlled CPU 101 and the network interface 106 shown in FIG. 2. The play list creating unit 24 receives a search request from the data recording/playing device 10, creates a play list as index information for a program appropriate to the search request and sends it back to the data recording/playing device 10. A play list is created by searching for and collecting annotation information for a program that matches a search request and scenes contained in the program from annotation information stored in the annotation information storing unit 23.

Assume that the annotation information shown in FIG. 7 is stored in the annotation information storing unit 23 for a given program and a search request has been received that requests “goal” in the program. In this case, the play list creating unit 24 searches annotation information shown in FIG. 7 from the annotation information storing unit 23, extracts data that have keywords “soccer, goal”, and collects data on dates and times that locate the scenes so as to create a play list. If a condition that commercials should be omitted is attached to the search request, the data for the portion between 20:55:03 and 20:55:15 will not be contained in the play list of annotation information shown in FIG. 7. In addition, if annotation information has been created, a play list that contains only recordings of goal scoring by one team or that contains only set plays can be created. It is also possible to specify a plurality of programs and create a play list that contains scenes matching certain conditions.

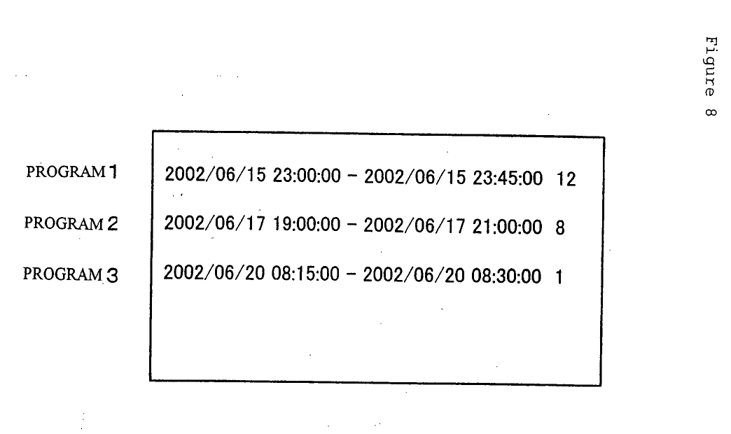

A procedure of a scene search using the embodiment will be described in detail in the following. Assume as an initial condition that data on three programs shown in FIG. 8 is stored as a program list in the program storing unit 12 of the data recording/playing device 10. Each of the programs is identified by a date and time of broadcast and a channel (information on dates and times and channels is cached in the search request unit 13 as registered in the program list). For example, program 1 in FIG. 8 is a program that was broadcast on channel 12 from 23:00:00 to 23:45:00 on Jun. 15, 2002.

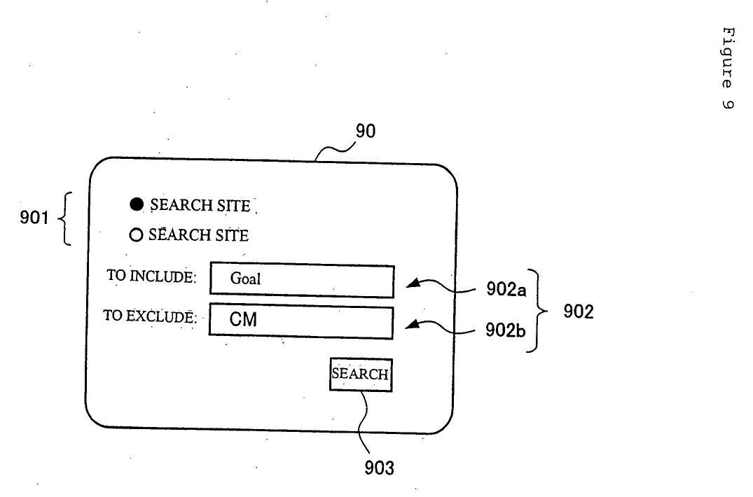

First, at the data recording/playing device 10, the user enters search conditions and a search request is generated. FIG. 9 shows an example of the design of an entry screen (search screen) for search conditions. A search screen 90 in FIG. 9 has a search-site specifying field 901 for specifying a search site (search server 20), an entry form 902 for entering search conditions, and a search button 903. The search-site specifying field 901 is for specifying to which search site one will request a search when a plurality of search servers 20 exist on the network 30. The entry form 902 is for entering search conditions for searching for scenes in a desired program. The search button 903 is a button object for issuing a submit command for a search request, and selection of the search button 903 after selecting a search site and entering search conditions will issue and send a search request to the specified search site (search server 20).

A search condition for a search request can be specified by entering a character string corresponding to a keyword for annotation information shown in FIGS. 5 to 7 in the entry form 902. The entry form 902 of FIG. 9 has a field 902a for entering a keyword for annotation information that should be contained in a play list (a search keyword), and a field 902b for entering a keyword for annotation information that should be omitted from the play list (an excluded keyword). For example, as shown in FIG. 9, by typing “goal” in the field 902a, annotation information that has the keyword “goal” will be retrieved. And by typing “CM” in the field 902b, any annotation information that has the keyword “CM” will be excluded from retrieved annotation information. Processing such as normalization is performed in the keyword search.

After the search conditions have been set and the search button 903 has been selected, a search request that uses the input to the entry form 902 as search conditions and that contains the program list shown in FIG. 8 is issued and sent to a search server 20 that corresponds to search site A that has been specified. Although not shown in the figure, a field for specifying a program to be searched may be provided in the search screen 90 in FIG. 9. This would allow a search request to be issued that targets only a specified program, rather than targeting information on all programs in a program list stored in the program storing unit 12.

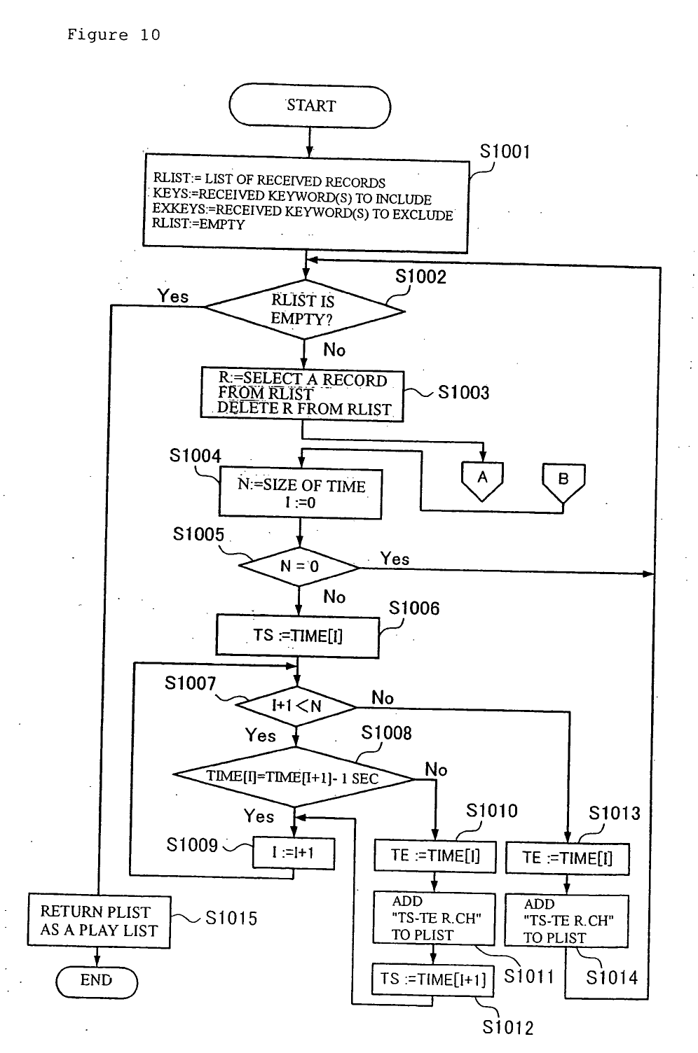

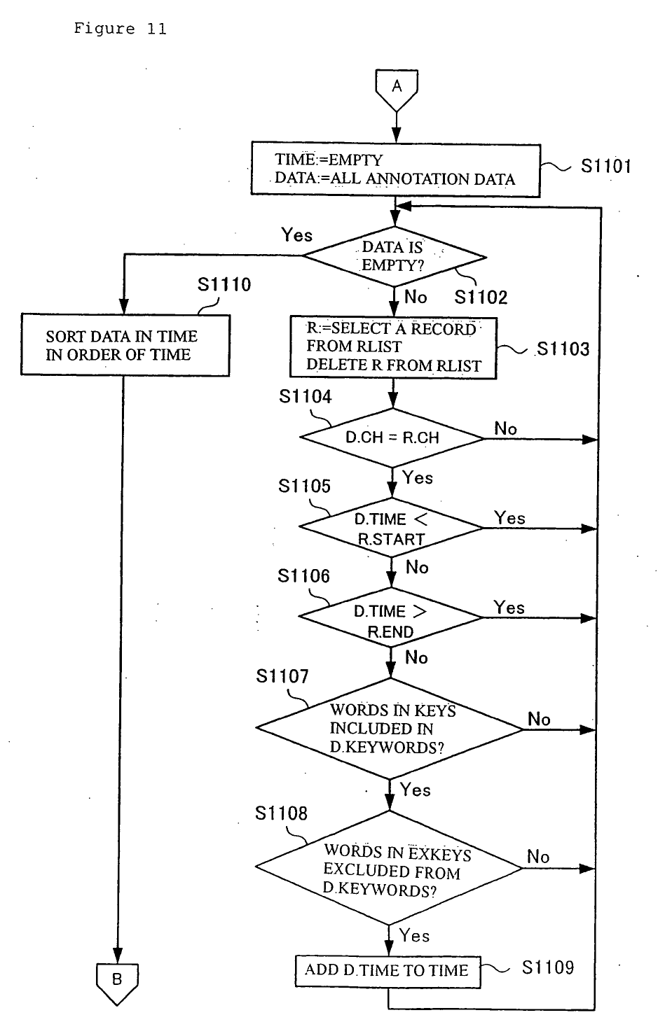

FIGS. 10 and 11 are flowcharts showing the operation of the play list creating unit 24 of the search server 20 that has accepted a search request from a given data recording/playing device 10. For the operation, assume that each piece of data in a program list contained in the search request sent from the data recording/playing device 10 has fields for a channel (CH), a start time of a program (START), and an end time of the program (END). The search request also contains a search keyword (KEYS) and an excluded keyword (EXKEYS) as search conditions. Meanwhile, each piece of data of annotation information stored in the annotation information storing unit 23 has fields for a channel (CH), a time (TIME), and keywords (KEYWORDS) as shown in FIG. 7.

With reference to FIG. 10, the play list creating unit 24 first extracts a program list (RLIST), a search keyword (KEYS), and an excluded keyword (EXKEYS) from the received search request and creates a play list (PLIST) (step 1001). In an initial state, the values of the play list are empty.

Then, the play list creating unit 24 selects a program from the program list and sets it as target program R and deletes R from the program list (steps 1002 and 1003). For the target program R, the play list creating unit 24 performs a series of processes shown in FIG. 11 to find times with which annotation information matches.

Turning to FIG. 11, the play list creating unit 24 first sets TIME and DATA as parameters, setting the value of TIME to empty and that of DATA to all annotation information stored in the annotation information storing unit 23 (step 1101).

The play list creating unit 24 then selects a record from annotation information in DATA, sets it as target data D, and deletes D from DATA (steps 1102 and 1103). The play list creating unit 24 makes determinations as follows for the target data D and each piece of data in the program list. The play list creating unit 24 first determines whether channels in both pieces of information are the same (D.CH=R.CH) (step 1104) and then checks if the time contained in the annotation information falls between the start time and end time in the program list data (R.START≦D.TIME≦R.END) (steps 1105 and 1106). It then checks if the search keyword is included in the keywords of the target data D (step 1107), and further determines if the excluded keyword is included in the keywords (step 1108).

For the target data D and given data in the program list, if the two channels are the same, the time falls between the start time and end time in the data of the program list, the keywords include the search keyword but not the excluded keyword, the play list creating unit 24 additionally registers D.TIME, i.e., information on time in the target data D, to parameter TIME (step 1109). If the program list contains no such data, the play list creating unit 24 does not register D.TIME, information on time in the target data D, to parameter TIME (steps 1104 to 1108).

After those processes, the play list creating unit 24 determines if parameter DATA is empty, that is, if the processes at steps 1103 to 1109 have been done for all annotation information (step 1102). If DATA still has annotation information, the play list creating unit 24 selects a record from the annotation information and performs the same processes for the record. On the other hand, if DATA is empty, it sorts data that has been stored in TIME through processing up to this point in a chronological order (step 1110).

In this way, times that match the target program R of the search request are obtained from annotation information. Then, from the sequence of times obtained from the processes of FIG. 11 (for example, 20:15:03, 20:15:04, 20:15:05, 20:31:45, . . . ), continuous portions (from 20:15:03 to 20:15:05, from 20:31:45 to . . . ) are separated to create entries of a play list.

Specifically, when the processes shown in FIG. 11 are completed for the target program R, the play list creating unit 24 sets parameters N and I, setting the value of N to the size of TIME and that of I to zero (step 1004). And it sets the value of TIME (TIME[I]) when I=0 as TS (steps 1005 and 1006), and registers data to the play list through a series of operations as follows while incrementing I by one until I+1=N (step 1007).

The play list creating unit 24 first checks to see if an equation:

TIME[I]=TIME[I+1]−1 SECOND (1)

holds (step 1008). If the equation holds, TIME[I] and TIME[I+1] are continuous. The play list creating unit 24 thus increments I by one (step 1009) and returns to step 1007.

In contrast, if equation (1) does not hold, it indicates that TIME[I] and TIME[I+1] are not continuous. Thus, the entries of the play list are separated there. In particular, TIME[I] at this point is set as TE (step 1010), and the value of time TS-TE and channel information R.CH are registered as one entry of the play list (step 1011). Then, TIME[I+1] is set as TS anew (step 1012), I is incremented by one (step 1009) and the process returns to step 1007.

The play list creating unit 24 repeats the process and when the I+1 reaches N, it sets TIME[I] at this point as TE (step 1013) and registers the value of time TS-TE and channel information R.CH as one entry of the play list (step 1014).

After the data registration to the play list at step 1014, the play list creating unit 24 determines whether RLIST is empty, that is, whether the processes at steps 1003 to 1014 have been performed for all programs in the program list extracted from the search request (step 1002). If any program remains unprocessed, it selects the program and performs the same process for it. On the other hand, if the program list is empty, the play list (PLIST) created up to this point is sent back to the data recording/playing device 10 that issued the search request (step 1015). On receiving the play list from the search server 20, the search request unit 13 of the data recording/playing device 10 displays it on the monitor.

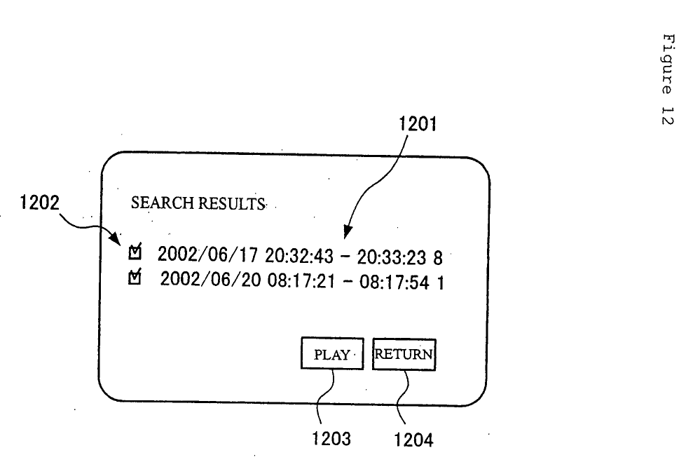

FIG. 12 shows an example of a screen displaying a play list as a search result. The display screen in FIG. 12 shows the contents of a play list 1201 and also has check boxes 1202 for each play list data so that the user can specify a program he/she wants to replay. The screen also has a button object 1203 for issuing a replay command for a program specified with the check box 1202 and a button object 1204 for returning to the search screen shown in FIG. 9.

The example in FIG. 12 shows that portions of programs broadcast from 20:32:43 to 20:33:23 on Jun. 17, 2002 (on Channel 8) and from 8:17:21 to 8:17:54 on Jun. 20, 2002 (on Channel 1) have been retrieved by the search server 20 as programs that match the search conditions. Further, because both the checkboxes for the data are checked in the example, the two programs will be replayed if the button object 1203 is selected in this state.

While selection of search sites has been described in connection with the search screen in FIG. 9, the number of search servers 20 provided on the network 30 is not limited to one as shown in FIG. 1 in this embodiment. Considering that stations and programs of television broadcast vary in regions, it is not feasible that a single search site receives all broadcasts and preserves annotation information for them. Rather, by providing the search servers 20 for each broadcast station or constructing a search site that specializes in a particular category of programs (e.g. sports programs), a more detailed service could be provided.

It is also possible for a plurality of search sites to generate annotation information and offer search services for the same program. This approach is preferable in that individual search sites develop their own characters by generating annotation information in different ways and the user of the data recording/playing device 10 can select a search site he or she likes and request the site to perform a search.

Further, although annotation information is generated by the annotation information generating unit 22 of the search server 20 in the embodiment described above, annotation information prepared by creators of programs or at broadcast stations may be distributed to the search server 20.

Although the description of the embodiment has addressed a case where scenes in a motion picture program are categorized by contents and annotation information is generated by specifying a broadcast channel and dates and times of broadcast, contents of annotation information are not thus limited. For example, for a video program that has been created and distributed for specific users, rather than a program that has been broadcast, scenes in the program can be categorized and identified on the basis of index information added to the program in advance, rather than broadcast times. When annotation information is generated for a program in digital form, the contents of the program can be categorized in accordance with the type and presence of a predetermined signal that is embedded with digital watermarking and the like.

While the embodiment described above is directed mainly for motion picture programs that have been delivered on television, it is understood that the embodiment can be applied to audio or still picture programs by generating appropriate annotation information.

As has been described, according to the invention, a system can be implemented that provides a detailed and flexible function of searching programs for a data recording/playing device that records programs such as those delivered on television.

1. A network system comprising:
a data recording device for storing at least one program; and
a server for holding information on said at least one program stored in said data recording device and generating, in response to a request from said data recording device, a playlist to be used for playing all or part of said at least one program on the basis of the information on said at least one program to send the playlist to said data recording device.

2. The network system according to claim 1, wherein said server searches information on said at least one program on the basis of a search condition specified in the request from said data recording device to generate the playlist by using the result of the search.

3. The network system according to claim 1, wherein said server analyzes a copy of all or part of said at least one program stored in said data recording device, to generate information on said at least one program on the basis of the result of the analysis.

4. The network system according to claim 1, wherein the playlist includes at least one play item which causes said data recording device to play a portion of said at least one program.

5. A server comprising:
an annotation information storing unit for storing annotation information which contains information on at least one program delivered;
an annotation information search unit for searching the annotation information matching the search condition and the at least one program specified in a search request received via a network; and
a playlist generation unit for generating a playlist to be used for playing at least one program by using the search result to send the playlist to a requester of the search.

6. The server according to claim 5, further comprising:
a program receiving unit for receiving at least one broadcasted program; and
an annotation information generation unit for generating, by analyzing said at least one broadcasted program received by the program receiving unit, annotation information to store the annotation information in the annotation information storing unit.

7. The server according to claim 6, wherein the annotation information further contains information on a broadcast station which broadcasts said at least one broadcasted program, a date and time of broadcast, and the type of program.

8. The server according to claim 6, wherein the playlist includes at least one play item which is used for identifying a portion of said at least one broadcasted program by using the broadcast time of said at least one broadcasted program.

9. A data recording/playing device comprising:
a program storing unit for storing at least one program as data file;
a search request unit for generating a search request which contains information said at least one broadcasted program and a search condition to send the search request to a server; and
a program playing unit for playing whole or part of said at least one broadcasted program stored in the program storing unit on the basis of the response from said server to the search request.

10. The data recording/playing device according to claim 9, further comprising:
a program receiving unit for receiving a broadcast program to be stored in the program storing unit;
means for obtaining information on a broadcast station which broadcast said at least one program and a broadcast time from conditions at reception of said at least one broadcasted program; and
means for passing the information and the time to the search request unit as identifying information of said at least one broadcasted program.

11. The data recording/playing device according to claim 10, wherein
the search request unit obtains the broadcast time of said at least one broadcasted program requested by a search request as a response to the search request, and
the program playing unit plays a portion corresponding to the broadcast time obtained as a response to the search request in said at least one broadcasted program stored in the program storing unit.

12. A program playing method for playing at least one broadcast program stored on a storage medium, comprising the steps of:
generating a search request containing information on at least one broadcast program and a search condition to send the search request to a server;
receiving information identifying a portion of said at least one broadcasted program as a response to the search request, the portion matches the search condition; and
playing said portion of said at least one program stored on the recording medium, said portion is identified by a response to the search request.

13. A data processing method comprising the steps of:
generating, by analyzing at least one broadcasted program, annotation information on a broadcast station which broadcasts said at least one broadcasted program, a date and time of broadcast, and the type of program;
searching the annotation information for information matching a search condition and a program specified in the search request; and
generating a playlist to be used for playing the program by using the search result to send a playlist to a requester of the search.

14. A program product for controlling a computer to play a program stored on a recording medium, the program causes the computer to execute the steps of:
generating a search request containing at least one program and a search condition to send the search request to a server;
receiving information identifying a portion of said at least one program as a response to the search request, the portion matches the search condition; and
playing said portion of said at least one program stored on the recording medium, said portion is identified by a response to the search request.

15. The program product according to claim 14, further causing the computer to execute a step of receiving a broadcast program and a step of obtaining information on a broadcast station which broadcasts the program and a broadcast time from conditions at reception of the program as identifying information of the program.

16. A program product for causing the computer to function as:
an annotation information storing unit for storing annotation information containing information on at least one program delivered;
an annotation information search unit for searching the annotation information matching a search condition and at least one program specified in a search request received via a network; and
a playlist generation unit for generating a playlist to be used for playing whole or part of said at least one program by using the search result to send a playlist to a requester of the search.

17. The program product according to claim 16, further causing the computer to function as an annotation information generation unit for generating, by analyzing a received broadcast program, annotation information for said at least one program.
